(19) United States
(12) Patent Application Publication
(10) Pub. No.: US 2014/0062837 A1
(43) Pub. Date: Mar. 6, 2014

(54) INFORMATION PROCESSING APPARATUS AND METHOD FOR SENDING DISPLAY DATA THEREFROM

(71) Applicant: TOSHIBA TEC KABUSHIKI KAISHA, Tokyo (JP)

(72) Inventor: Nobuhiro Inagawa, Shizuoka-ken (JP)

(73) Assignee: TOSHIBA TEC KABUSHIKI KAISHA, Tokyo (JP)

(21) Appl. No.: 13/965,390

(22) Filed: Aug. 13, 2013

(30) Foreign Application Priority Data
Sep. 4, 2012 (JP) 2012-194269

(51) Int. Cl. G06F 3/14

(52) U.S. Cl. CPC G06F 3/1423
USPC 345/2.1

(57) ABSTRACT

In accordance with an embodiment, an information processing apparatus includes a sending section and an acquiring section. The sending section sends the display data to a display apparatus arranged at each area in a store. The acquiring section acquires a crowded degree with customers in each area. The sending section changes the display data which is sent to the display apparatus arranged at the area of which at least the crowded degree is equal to or greater than a specified value within the display apparatuses respectively arranged at each area.

### CROSS-REFERENCE TO RELATED APPLICATION

This application is based upon and claims the benefit of priority from Japanese Patent Application No. 2012-194269, filed Sep. 4, 2012, the entire contents of which are incorporated herein by reference.

### FIELD

Embodiments described herein relate to an information processing apparatus and a method for sending display data from the information processing apparatus.

### BACKGROUND

In a digital signage system comprising a digital signage for displaying a signage such as an animation or a motion picture and the like of various commodities and a server sending the digital signage the content data of the signage displayed on the digital signage, a time schedule at which the signage of the commodity is displayed on the digital signage is previously set. In addition, the content data itself of the signage displayed on the digital signage is also created previously, and the content data is sent to the digital signage according to the time schedule.

### BRIEF DESCRIPTION OF THE DRAWINGS

FIG. 1 is a diagram illustrating schematic constitution of a store operation system according to a first embodiment;

FIG. 2 is a diagram illustrating an arrangement example of a digital signage apparatus in the store system according to the first embodiment;

FIG. 3 is a front view illustrating schematic external constitution of the digital signage apparatus according to the first embodiment;

FIG. 4 is a block diagram illustrating hardware arrangements of a control system of a store server according to the first embodiment;

FIG. 5 is a diagram illustrating constitution of various tables stored in the store server according to the first embodiment;

FIG. 6 is a block diagram illustrating hardware arrangements of a control system of the digital signage apparatus according to the first embodiment;

FIG. 7 is a block diagram illustrating functional constitution of the store server according to the first embodiment;

FIG. 8 is a block diagram illustrating functional constitution of the digital signage apparatus according to the first embodiment;

FIG. 9 is a flowchart illustrating a flow of the processing of sending content data in the store server according to the first embodiment;

FIG. 10 is a flowchart illustrating a flow of the processing of changing the content data sent to the digital signage apparatus in the store server according to the first embodiment;

FIG. 11 is a diagram illustrating the processing of changing the content data sent to the digital signage apparatus in the store server according to the first embodiment;

FIG. 12 is a diagram illustrating an example of changing the content data sent to the digital signage apparatus in the store server according to the first embodiment;

FIG. 13 is a flowchart illustrating a flow of the display processing of various kinds of information in the digital signage apparatus according to the first embodiment;

FIG. 14 is a block diagram illustrating functional constitution of the store server according to a second embodiment;

FIG. 15 is a diagram illustrating the processing of changing the content data sent to the digital signage apparatus in the store server according to the second embodiment;

FIG. 16 is a block diagram illustrating the functional constitution of the store server according to a third embodiment; and

FIG. 17 is a diagram of the processing of changing the content data sent to the digital signage apparatus in the store server according to the third embodiment.

### DETAILED DESCRIPTION

In accordance with an embodiment, an information processing apparatus includes a sending section and an acquiring section. The sending section sends a display data to a display apparatus arranged at each area in a store. The acquiring section acquires a crowded degree with customers in each area. The sending section changes the display data which is sent to the display apparatus arranged at the area of which the crowded degree is equal to or greater than a specified value within the display apparatuses respectively arranged at each area.

### A First Embodiment

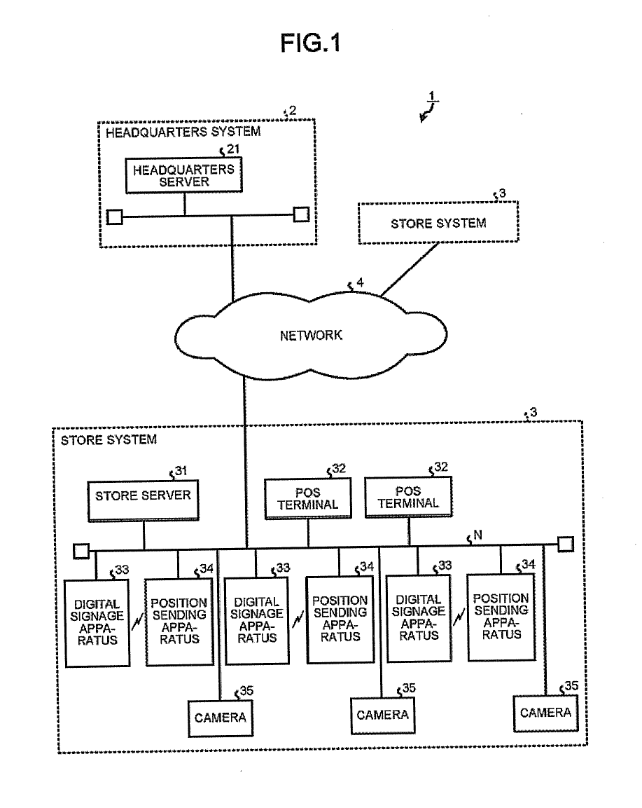

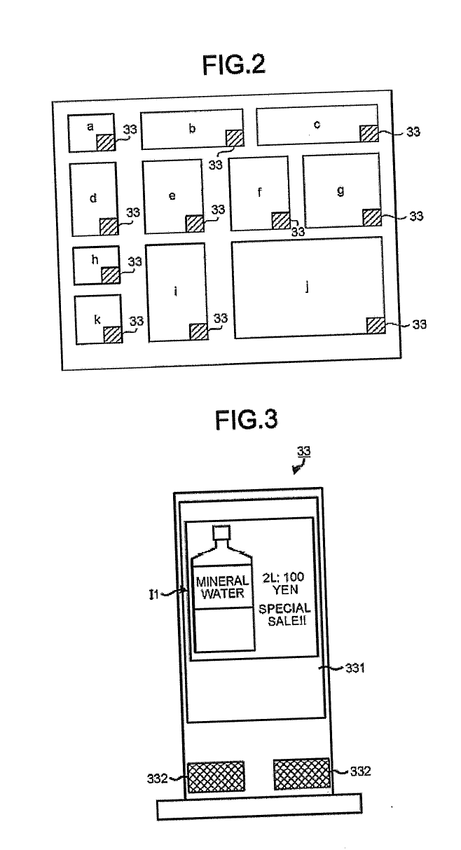

Hereinafter, embodiments are described with reference to the accompanying drawings. First, the schematic constitution of a store operation system in which the information processing apparatus and a program according to the present embodiment are used is described. FIG. 1 is a diagram illustrating the schematic constitution of the store operation system according to the first embodiment. FIG. 2 is a diagram illustrating an arrangement example of a digital signage apparatus in the store operation system according to the first embodiment.

As shown in FIG. 1, the store operation system 1 of the present embodiment comprises a headquarters system 2 and a plurality of store systems 3 (two in FIG. 1). The headquarters system 2 and each store system 3 are connected through a public communication network such as Internet and the like, a network 4 such as a VPN (Virtual Private Network) and the like, and a connector such as a router and the like which are not shown in Figs.

The headquarters system 2 is installed in the headquarters collectively managing each store, and comprises a headquarters server 21, a printer and a personal computer and the like (all not shown in Figs.).

The store system 3 is arranged in each store, and comprises a store server 31, a plurality of POS (Point Of Sales) terminals 32, a plurality of digital signage apparatuses 33, a plurality of position sending devices 34 and a plurality of cameras 35, and these apparatuses are mutually connected through a communication network N such as a LAN (Local Area Network) and the like.

The store server 31 is arranged in an office of the store, and is an information processing apparatus serving as a host apparatus collectively managing all of the store system 3. The store server 31 carries out the sales management based on the sales data sent from the POS terminals 32. In addition, the store server 31 sends the content data, such as an animation, a still image and the like, for displaying various kinds of information such as an advertisement information for advertising a commodity sold in each area in the store or a service provided in each area, and a guidance information for guiding a path leading to each area, and the like, to each digital signage apparatus 33 through the communication network N.

Each POS terminal 32 is an information processing apparatus arranged at a checkout place in the store, and performs transmission/reception of commodity information (commodity code, commodity name, unit price and the like) with the store server 31 through the communication network N to carryout the registration and settlement of the commodity purchased by a customer.

As shown in FIG. 2. each digital signage apparatus 33 is a display apparatus arranged in areas a-k (sales floor for selling commodity, entrance of the store, and the like) in the store, and reproduces content data (display data) received from the store server 31 through the communication network N to display various kinds of information on a display section 331 (referring to FIG. 3). More specifically, each digital signage apparatus 33 reproduces the received content data to display various kinds of information such as an advertisement information I1 (referring to FIG. 3) including animation in which a commodity advertised to customers is photographed, the price of the commodity mentioned above, and a message introducing (or explaining) the commodity mentioned above to the customers, and a guidance information for guiding a path leading to the area at which the advertised commodity or service is provided to the customers on the display section 331, and outputs a voice introducing the advertised commodity to the customers from a sound output section 332 (referring to FIG. 3).

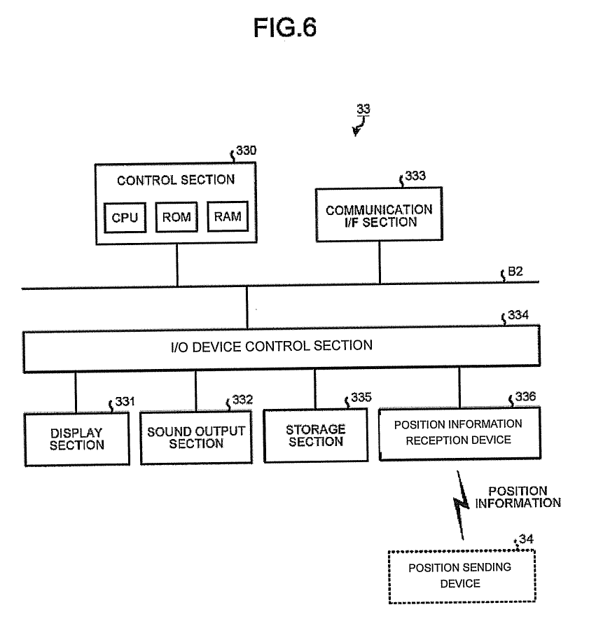

The position sending device 34 sends position information. The position sending device 34 comprises, for example, an RFID (Radio Frequency Identification) tag including a wireless IC chip with an antenna which stores own-position information. The position information stored in the wireless IC chip is read by a position information reception device (reader-writer) 336 (referring to FIG. 6) of the digital signage apparatus 33.

The camera 35 is arranged at each area in the store, and captures an image (photographed image) for acquiring a crowded degree with customers in each area. In the present embodiment, the camera 35 is arranged on a ceiling at each area in the store to capture the photographed image in which each area in the store is overlooked from the ceiling.

Next, the external constitution of the digital signage apparatus 33 is described. FIG. 3 is a front view illustrating the schematic external constitution of the digital signage apparatus according to the first embodiment. As shown in FIG. 3, the digital signage apparatus 33 comprises the display section 331 and the sound output section 332.

The display section 331 comprises a liquid crystal display or a plasma display and the like to display various kinds of information such as the advertisement information I1 and the guidance information and the like based on the content data received from the store server 31.

The sound output section 332 comprises a speaker and the like to output various sounds such as BGM, a voice introducing a commodity and the like, based on the content data received from the store server 31.

The digital signage apparatus 33 shown in FIG. 3 comprises the display section 331 and the sound output section 332, but it is not limited to these. The digital signage apparatus 33 may also comprise other components such as a printer for printing various tickets, coupons and the like to issue them, a reading device for reading information such as an ID and the like of a customer from a storage medium such as a membership card or a mobile phone and the like held by the customer, a communication device for carrying out a short-distance communication with the mobile phone held by the customer, and a photographing device (camera) for capturing an image from which a crowded degree with customers in each area is acquired.

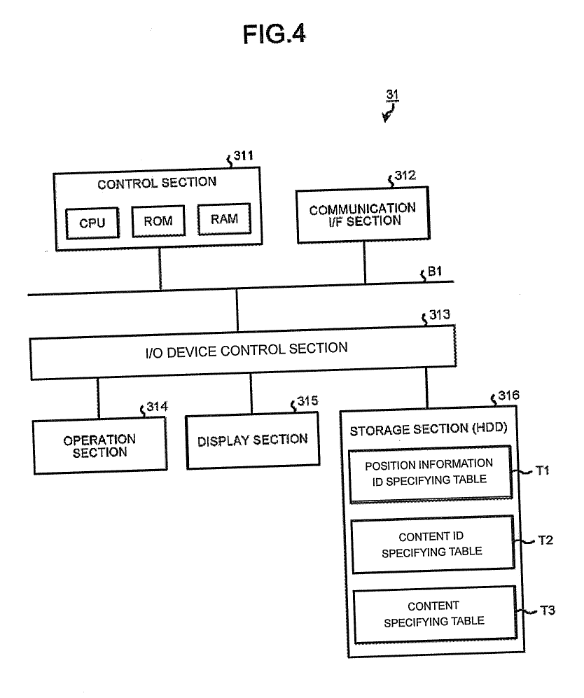

A hardware arrangement of control system of the store server 31 is described. FIG. 4 is a block diagram illustrating the hardware arrangement of the control system of the store server according to the first embodiment.

As shown in FIG. 4, the store server 31 has the hardware arrangement, utilizing a general computer, in which a control section 311, a communication I/F section 312 and an I/O device control section 313 are mutually connected with a bus line B1. The control section 311 comprises a CPU (Central Processing Unit), a ROM (Read Only Memory), a RAM (Random Access Memory) and the like.

The control section 311 is connected with an operation section 314 having a keyboard and a mouse, a display section 315 having a liquid crystal display and the like, and a storage section 316 such as an HDD (Hard Disk Drive) and an SSD (Solid State Drive) through the bus line 31 and the I/O device control section 313.

The control section 311 controls operations of various components connected through the I/O device control section 313 by executing a control program, developed in the RAM, that is stored in the ROM or the HDD by the CPU. The control section 311 also controls transmission/reception operation of various data such as a commodity information, a content data and the like with the POS terminal 32 and the digital signage apparatus 33 connected through the communication I/F section 312 and the communication network N.

The storage section 316 stores various kinds of information such as the content data sent to each digital signage apparatus 33, a commodity master table for registering commodity information (information denoting the commodity name and unit price corresponding to the commodity code of each commodity, and the like) of each commodity sold in the store, and a sales master table for registering sales information denoting the commodity sales data (the number of sales and sales amount of each commodity in a certain period such as one business day and the like) based on sales data received from the POS terminal 32. The storage section 316 also stores a position information ID specifying table T1, a content ID specifying table T2, and a content specifying table T3 and the like.

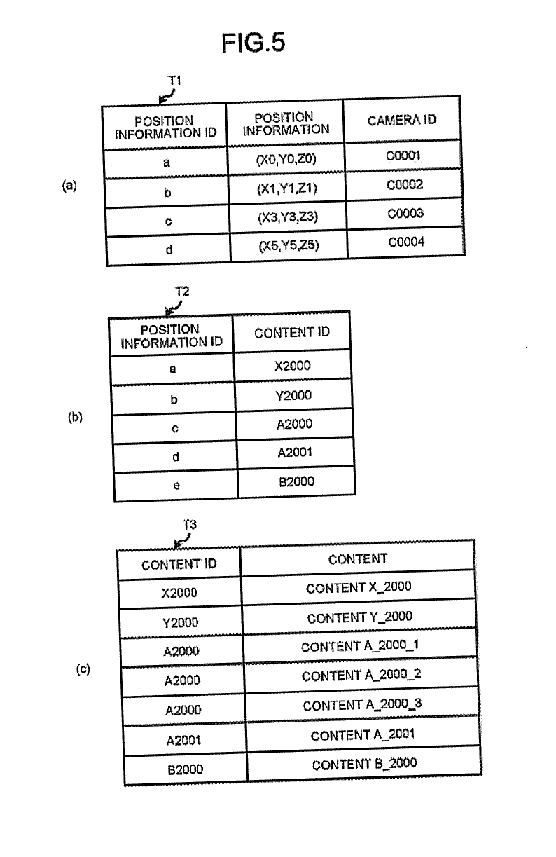

FIG. 5 is a diagram illustrating configurations of various tables stored in the store server according to the first embodiment. As shown in FIG. 5(a), the position information ID specifying table T1 stores the position information, denoting the arrangement position (the area at which the digital signage apparatus 33 is arranged in the store) of each digital signage apparatus 33, which is notified from each digital signage apparatus 33, and a camera ID for distinguishing the camera 35 arranged at each area in association with a position information ID for distinguishing each area in the store. The position information is represented by a coordinate (X, Y, Z) to define each arrangement position (area) in the store.

As shown in FIG. 5(b), the content ID specifying table T2 stores, in association with the position information ID stored in the position information ID specifying table T1, a content ID for distinguishing the content data of various kinds of information displayed on the digital signage apparatus 33 arranged at the area distinguished by the position information ID.

As shown in FIG. 5(c), the content specifying table T3 stores, in association with the content ID stored in the content ID specifying table T2, the content data distinguished by the content ID. The content data corresponds to the area at which the digital signage apparatus 33 is arranged. Specifically, the content data includes the animation and the still image and the like for displaying various kinds of information such as an advertisement information for advertising the commodity sold in the area at which each digital signage apparatus 33 is arranged or the service provided in the area, and a guidance information for guiding a path leading to the area to the customer, or notifying them to the customer with a voice.

Next, hardware arrangement of a control system of the digital signage apparatus 33 is described. FIG. 6 is a block diagram illustrating the hardware arrangement of the control system of the digital signage apparatus according to the first embodiment.

As shown in FIG. 6, the digital signage apparatus 33 comprises a hardware arrangement, utilizing a general computer, in which a control section 330, a communication I/F section 333 and an I/O device control section 334 are mutually connected with a bus line B2. The control section 330 comprises a CPU (Central Processing Unit), a ROM (Read Only Memory), a RAM (Random Access Memory) and the like.

In addition, the control section 330 is connected with a display section 331 with a liquid crystal display or a plasma display and the like, a sound output section 332 with a speaker, a storage section 335 such as an HDD (Hard Disk Drive), an SSD (Solid State Drive), a nonvolatile memory, and the like are connected through the bus line B2 and the I/O device control section 334.

The control section 330 controls operations of various components connected through the I/O device control section 334 by executing a control program, developed in the RAM, that is stored in the ROM or the HDD by the CPU. The control section 330 also controls transmission/reception operation of various data such as a content data and the like with the store server 31 connected through the communication I/F section 333 and the communication network N.

The storage section 335 stores various kinds of information such as a content data and the like received from the store server 31.

A position information reception device 336 receives position information for specifying the arrangement position of itself from the position sending device (RFID tag) 34. In the present embodiment, the position information reception device 336 includes, for example, a reader-writer and the like, to receive the position information from the position sending device (RFID tag) 34 positioned nearby.

FIG. 7 is a block diagram illustrating a functional constitution of the store server according to the first embodiment. As shown in FIG. 7, the control section 311 of the store server 31 in which the CPU executes a program, developed in the RAM, that is stored in the ROM and the like functions as a position inquiry section 311a, a crowded degree acquiring section 311b and a sending section 311c.

The position inquiry section 311a inquires an area at which each digital signage apparatus 33 is installed. Specifically, the position inquiry section 311a instructs each digital signage apparatus 33 to send each position information for specifying the arrangement position of each digital signage apparatus 33, and receives the position information sent from each digital signage apparatus 33 responding to the instruction. In addition, the position inquiry section 311a receives discrimination information (an IP address, a signage ID and the like) for distinguishing each digital signage apparatus 33 together with its position information.

The crowded degree acquiring section 311b acquires a captured image from the camera 35 arranged at each area at predetermined time intervals, and also acquires a crowded degree with customers in each area, using the captured image acquired. In the present embodiment, the crowded degree acquiring section 311b acquires the image captured by the camera 35 and its camera ID from the camera 35 arranged at each area at the predetermined time intervals. Afterwards, the crowded degree acquiring section 311b further acquires size of the area specified by the position information ID stored in the position information ID specifying table T1 in association with the camera ID acquired. In the present embodiment, the crowded degree acquiring section 311b previously stores the size of each area in the store. Next, the crowded degree acquiring section 311b divides the number of customers included in the captured image of each area by the size of each area to acquire the density of customers in each area as a crowded degree. Afterward, the crowded degree acquiring section 311b transfers the acquired crowded degree of each area to the sending section 311c. At the moment, the crowded degree acquiring section 311b adds the specified position information ID (the position information ID for distinguishing the area of which the crowded degree is acquired) to the crowded degree acquired. In the present embodiment, the crowded degree acquiring section 311b acquires the crowded degree by utilizing the image captured by the camera 35 arranged in each area. However, if the digital signage apparatus 33 is equipped with a camera (not shown), the crowded degree may be acquired by utilizing the image captured by the camera of the digital signage apparatus 33.

In addition, in the present embodiment, the crowded degree acquiring section 311b specifies the number of customers in each area from the captured image of the camera 35 arranged in each area, but it is not limited to that. For example, line of flow (traffic line) information (see Japanese Unexamined Patent Publication No. 2000-200357) of a person included in the image captured by the cameras arranged at a plurality of positions in the store is stored, and the number of customers in each area may be specified based on the stored line of flow information.

The sending section 311c sends the content data of various kinds of information to the digital signage apparatus 33 arranged at each area in the store to display it on the digital signage apparatus 33. In the present embodiment, the sending section 311c specifies the position information ID stored in the position information ID specifying table T1 corresponding to the position information consistent with the position information received by the position inquiry section 311a. Next, the sending section 311c specifies the content ID stored in the content ID specifying table T2 corresponding to the specified position information ID. Subsequently, the sending section 311c acquires the content data stored in the content specifying table T3 corresponding to the specified content ID. Finally, the sending section 311c sends the acquired content data to the digital signage apparatus 33 with the corresponding IP address which is previously received by the position inquiry section 311a as described above.

In addition, the sending section 311c changes the content data which is sent to the digital signage apparatus 33 arranged at the area of which at least the crowded degree is equal to or greater than a specified value within the digital signage apparatuses 33 arranged in the areas. In the present embodiment, the sending section 311c changes the content data which is sent to the digital signage apparatus 33 arranged in the area of which the crowded degree acquired by the crowded degree acquiring section 311b is equal to or greater than the specified value to the content data which is sent to the digital signage apparatus 33 arranged in the area of which the crowded degree acquired by the crowded degree acquiring section 311b is smaller than a second specified value lower than the specified value. Specifically, the sending section 311c specifies a crowded degree equal to or greater than the specified value and a crowded degree smaller than the second specified value within the crowded degrees of areas received from the crowded degree acquiring section 311b. The sending section 311c specifies the content ID corresponding to the position information ID added to the crowded degree smaller than the second specified value in the content ID specifying table T2. Next, the sending section 311c changes the content data which is sent to the digital signage apparatus 33 arranged in the area specified with the position information ID added to the crowded degree equal to or greater than the specified value to the content data stored in the content specifying table T3 corresponding to the specified content ID.

In the present embodiment, the sending section 311c changes the content data which is sent to the digital signage apparatus 33 arranged in the area of which the crowded degree is equal to or greater than the specified value according to the crowded degrees of areas finally acquired by the crowded degree acquiring section 311b, but it is not limited to that. For example, the sending section 311c may change the content data which is sent to the digital signage apparatus 33 arranged in the area of which the crowded degree is equal to or greater than the specified value according to the crowded degrees acquired in a period from the current time to the past specified time or the crowded degrees of the areas acquired during past several days, and the like. Furthermore, the sending section 311c may also change the content data which is sent to the digital signage apparatus 33 arranged in each area according to the quality of customers or clientele (for example, one person, a married couple, with a child, a male/female, an age and the like) included in the captured image of each area. For example, the sending section 311c changes the content data which is sent to the digital signage apparatus 33 arranged in the area of which the crowded degree is equal to or greater than the specified value to the content data which is sent to the area at which toys are sold if there are a lot of customers with children in the area as a quality of customers included in the captured image of each area.

In addition, in the present embodiment, the sending section 311c changes the content data which is sent to a plurality of digital signage apparatuses 33 arranged in the area of which the crowded degree is equal to or greater than the specified value if the plurality of digital signage apparatuses 33 are arranged in each area.

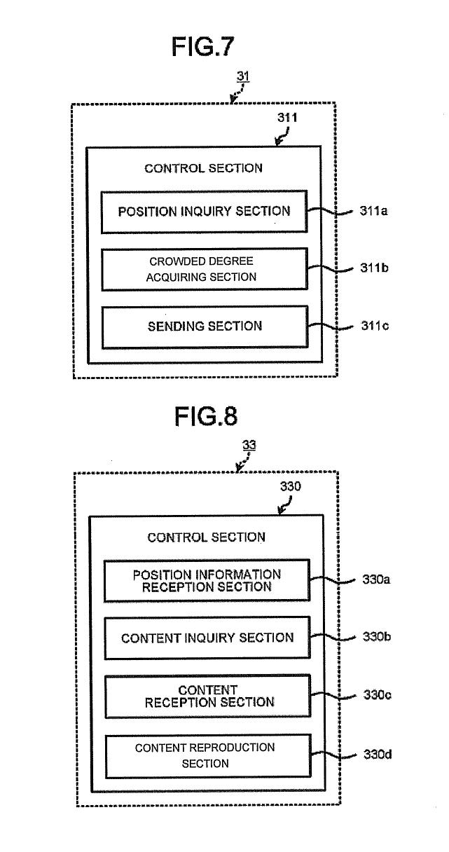

FIG. 8 is a block diagram illustrating a functional constitution of the digital signage apparatus according to the first embodiment. As shown in FIG. 8, the control section 330 of the digital signage apparatus 33 in which the CPU executes a program, developed in the RAM, which is stored in the ROM functions as a position information reception section 330a, a content inquiry section 330b, a content reception section 330c and a content reproduction section 330d.

The position information reception section 330a receives position information for specifying arrangement position of itself. In the present embodiment, the position information reception section 330a acquires the position information read from the position sending device 34 positioned near itself (digital signage apparatus 33) by the position information reception device 336 as a position information for specifying the arrangement position of itself at predetermined time intervals, and stores the position information in the storage section 335.

The content inquiry section 330b notifies the store server 31 of the position information, stored in the storage section 335, which is received by the position information reception section 330a.

The content reception section 330c receives the content data sent from the store server 31 responding to the notice from the content inquiry section 330b.

The content reproduction section 330d reproduces various kinds of information such as an advertisement information and guidance information from the content data received by the content reception section 330c, and outputs the various kinds of information reproduced through the display section 331 or the sound output section 332.

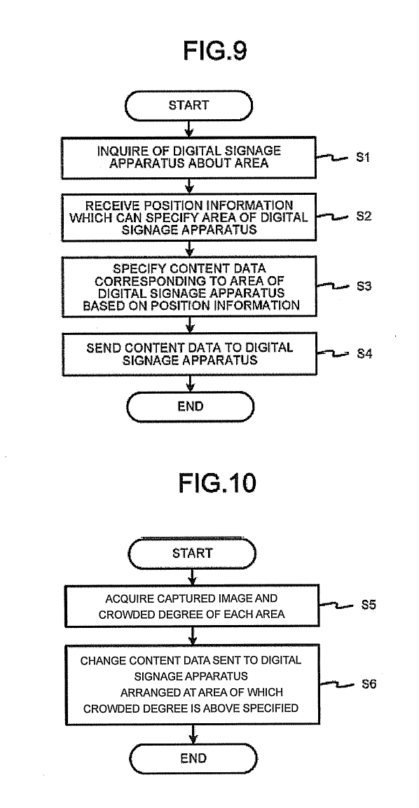

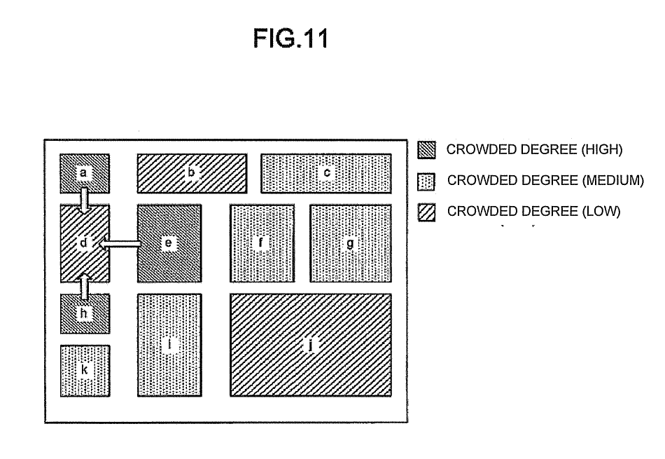

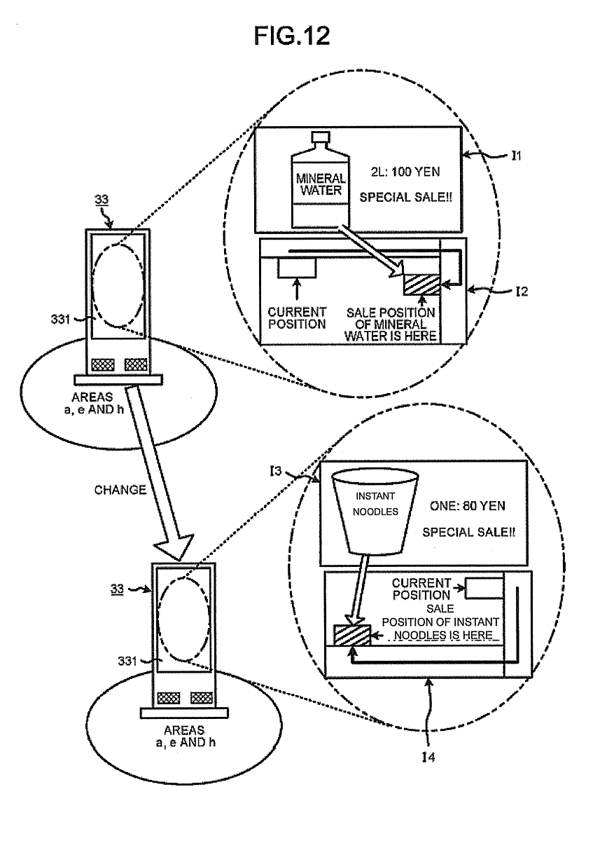

Next, processing in the store server 31 is described with reference to FIG. 9 to FIG. 12. FIG. 9 is a flowchart illustrating a flow of the processing of sending the content data in the store server according to the first embodiment. FIG. 10 is a flowchart illustrating a flow of the processing of changing the content data which is sent to the digital signage apparatus in the store server according to the first embodiment. FIG. 11 is a diagram illustrating the processing of changing the content data which is sent to the digital signage apparatus in the store server according to the first embodiment. FIG. 12 is a diagram illustrating a modification of changing the content data which is sent to the digital signage apparatus in the store server according to the first embodiment.

The position inquiry section 311a inquires of each digital signage apparatus 33 about the area at which each digital signage apparatus 33 is arranged at predetermined time intervals (ACT S1). Subsequently, the position inquiry section 311a receives the position information notified from each digital signage apparatus 33 responding to the inquiry (ACT S2).

The sending section 311c specifies content data respectively corresponding to each area at which each digital signage apparatus 33 is arranged based on the position information received by the position inquiry section 311a with reference to the position information ID specifying table T1, the content ID specifying table T2 and the content specifying table T3 (ACT S3).

Subsequently, the sending section 311c sends each content datum specified in ACT S3 to the digital signage apparatus 33 with a corresponding IP address (ACT S4).

The crowded degree acquiring section 311b acquires the captured images from the cameras 35 respectively arranged in each area at predetermined time intervals when the transmission processing of the content data shown in FIG. 9 is started, and also acquires the crowded degree in each area, using the captured images acquired (ACT S5).

The sending section 311c changes the content data that is sent to the digital signage apparatus 33 arranged in the area of which the crowded degree acquired is equal to or greater than the specified value within the digital signage apparatuses 33 respectively arranged in each area (ACT S6). For example, as shown in FIG. 11, the sending section 311c classifies the areas a-k in the store into the areas a, e and h (crowded degree: high) of which the crowded degrees are equal to or greater than the specified value, the areas b, d and j (crowded degree: low) of which the crowded degrees are smaller than the second specified value, or the areas c, f, g, i and k (crowded degree: medium) of which the crowded degrees are smaller than the specified value and equal to or greater than the second specified value. Afterwards, the sending section 311c changes the content data (for example, advertisement information I1 and guidance information I2 shown in FIG. 12) which is sent to the digital signage apparatuses 33 arranged in the areas a, e and h of which the crowded degrees are equal to or greater than the specified value to the content data (for example, advertisement information I3 and guidance information I4 shown in FIG. 12) which is sent to the digital signage apparatus 33 arranged in the area d of which the crowded degree is smaller than the second specified value. Thus, if there is an area of which the crowded degree is small in the store, various kinds of information such as the advertisement information, the guidance information and the like relating to commodities in the area are displayed in other areas, and therefore, the customers in other areas of which the crowded degrees are high can be guided to the area of which the crowded degree is low.

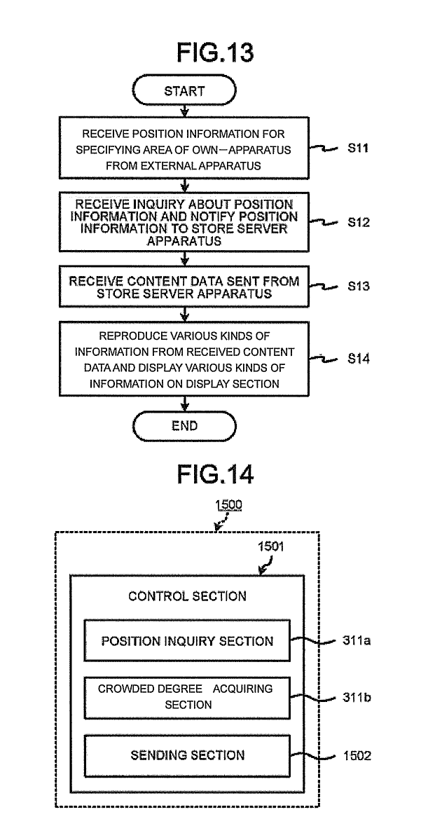

Next, processing in the digital signage apparatus 33 is described with reference to FIG. 13. FIG. 13 is a flowchart illustrating the display processing of various kinds of information in the digital signage apparatus according to the first embodiment.

The position information reception section 330a receives the position information for specifying the area at which the own-apparatus is arranged from the position sending device (an external apparatus) 34 and stores the position information in the storage section 335 at predetermined time intervals (ACT S11).

The content inquiry section 330b notifies the position information stored in the storage section 335 in ACT S11 to the store server 31 if the inquiry about the position information is received from the store server 31 (ACT S12).

Next, the content reception section 330c receives the content data corresponding to the area at which the own-apparatus is arranged sent from the store server 31 responding to the notice in ACT S12 (ACT S13).

The content reproduction section 330d reproduces various kinds of information such as the advertisement information, the guidance information and the like from the content data received in ACT S13 to display them on the display section 331 (ACT S14).

In this way, according to the first embodiment, the store server 31 sends the content data of various kinds of information that is displayed on the digital signage apparatuses 33 respectively arranged in each area in the store to each digital signage apparatus 33, and acquires the crowded degree with customers in each area to change the content data which is sent to the digital signage apparatus 33 arranged in the area of which at least the crowded degree is equal to or greater than the specified value within the digital signage apparatuses 33 respectively arranged in the areas in the store. The information displayed on the digital signage apparatus 33 arranged in the area of which the crowded degree is high is changed to the information of the commodity and the like sold in the area of which the crowded degree is low, for example, and therefore, costumers can be guided according to the crowded degree with customers in the store.

### A Second Embodiment

The second embodiment is an example in which the content data which is sent to the digital signage apparatus arranged in the area of which the crowded degree is high is changed to the content data including the special-sale information of a special-sale item within the commodities sold in each area. In the following explanation, descriptions of constitutions the same as those of the first embodiment are omitted.

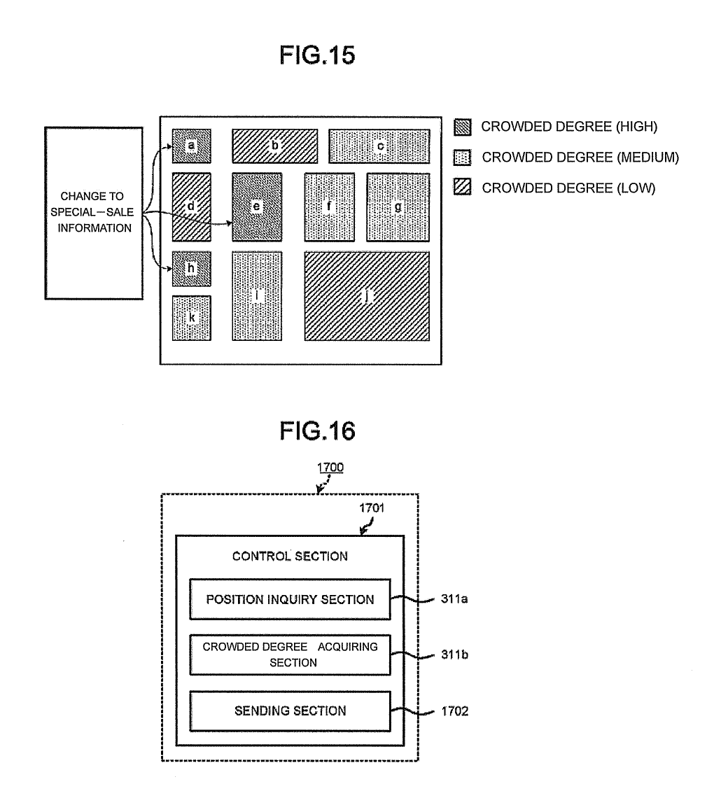

FIG. 14 is a block diagram illustrating the functional constitution of a store server according to the second embodiment. FIG. 15 is a diagram illustrating the processing of changing the content data sent to the digital signage apparatus in the store server according to the second embodiment. As shown in FIG. 14, a control section 1501 of a store server 1500 in which the CPU executes a program, developed in the RAM, which is stored in the ROM functions as the position inquiry section 311a, the crowded degree acquiring section 311b and a sending section 1502.

The sending section 1502 changes the content data which is sent to the digital signage apparatus 33 arranged in the area of which the crowded degree is equal to or greater than the specified value within the digital signage apparatuses 33 respectively arranged in each area to the content data including the special-sale information of the special-sale item within the commodities sold in the area. Specifically, the sending section 1502 specifies the crowded degree equal to or greater than the specified value within the crowded degrees of the areas acquired from the crowded degree acquiring section 311b. Next, the sending section 1502 reads out the special-sale information including the image, the name and the like of the special-sale item from the storage section 316. Afterwards, the sending section 1502 changes the content data which is sent to the digital signage apparatus 33 arranged in the area specified with the position information ID added to the crowded degree equal to or greater than the specified value to the read out special-sale information. Thus, the special-sale information is displayed in the area of which the crowded degree is high, and therefore, the effective advertisement can be performed.

For example, as shown in FIG. 15, the sending section 1502 specifies the areas a, e and h (crowded degree: high) of which the crowded degrees are equal to or greater than the specified value within the areas a-k in the store. Then, the sending section 1502 changes the content data which is sent to the digital signage apparatuses 33 arranged in the areas a, e and h of which the crowded degrees are equal to or greater than the specified value to the content data including the special-sale information. Thus, the special-sale information is displayed in the areas in which there are a lot of customers, and therefore, the effective advertisement for the commodity relating to the special-sale information can be realized.

As described above, according to the second embodiment, the store server 1500 changes the content data which is sent to the digital signage apparatus 33 arranged in the area of which the crowded degree is high to the content data including the special-sale information of the special-sale item within the commodities sold in each area to display the special-sale item in the areas in which there are a lot of customers. Therefore, the effective advertisement for the commodity relating to the special-sale information can be performed.

### A Third Embodiment

The third embodiment is an example in which the content data which is sent to the digital signage apparatus arranged in the area of which the crowded degree is equal to or greater than the specified value is changed to the content data which is sent to the digital signage apparatus arranged in the area excluding the area of which the crowded degree is equal to or greater than the specified value. In the following explanation, descriptions of the constitutions the same as those of the first embodiment are not repeated.

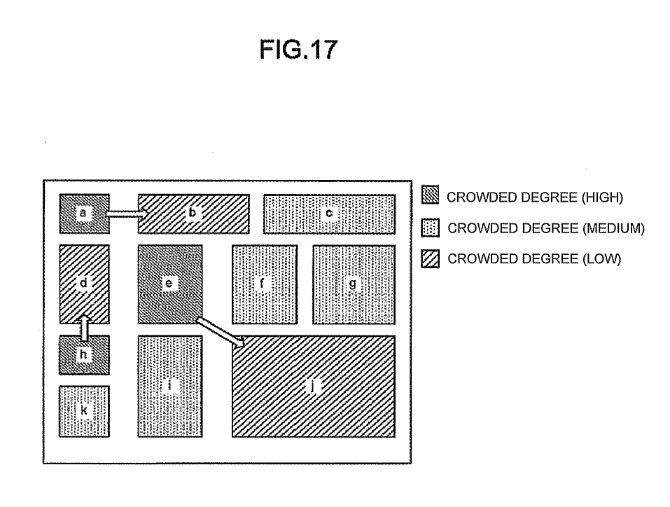

FIG. 16 is a block diagram illustrating the functional constitution of the store server according to the third embodiment. FIG. 17 is a diagram illustrating the processing of changing the content data which is sent to the digital signage apparatus in the store server according to the third embodiment. As shown in FIG. 16, a control section 1701 of a store server 1700 in which the CPU executes a program, developed in the RAM, which is stored in the ROM functions as the position inquiry section 311a, the crowded degree acquiring section 311b and a sending section 1702.

The sending section 1702 changes the content data which is sent to the digital signage apparatus 33 arranged in the area of which the crowded degree is equal to or greater than the specified value within the digital signage apparatuses 33 respectively arranged in each area to the content data which is sent to the digital signage apparatus 33 arranged in the area excluding the area of which the crowded degree is equal to or greater than the specified value. Specifically, the sending section 1702 specifies the crowded degree equal to or greater than the specified value and the crowded degree smaller than the second specified value (or the specified value) within the crowded degrees of all the areas received from the crowded degree acquiring section 311b. The sending section 1702 specifies the content ID corresponding to the position information ID added to the crowded degree smaller than the second specified value (or the specified value) in the content ID specifying table T2. Next, the sending section 1702 changes the content data which is sent to the digital signage apparatus 33 arranged in the area specified according to the position information ID added to the crowded degree equal to or greater than the specified value to the content data stored corresponding to the specified content ID in the content specifying table T3.

For example, as shown in FIG. 17, the sending section 1702 classifies the areas a-k in the store into the areas a, e and h (crowded degree: high) of which the crowded degrees are equal to or greater than the specified value, the areas b, d and j (crowded degree: low) of which the crowded degrees are smaller than the second specified value, or the areas c, f, g, i and k (crowded degree: medium) of which the crowded degrees are smaller the specified value and equal to or greater than the second specified value. Afterwards, the sending section 1702 changes the content data which is sent to the digital signage apparatus 33 arranged in the area a of which the crowded degree is equal to or greater than the specified value to the content data which is sent to the digital signage apparatus 33 arranged in the area b of which the crowded degree is smaller than the second specified value. In addition, the sending section 1702 changes the content data which is sent to the digital signage apparatus 33 arranged in the area e of which the crowded degree is equal to or greater than the specified value to the content data which is sent to the digital signage apparatus 33 arranged in the area j of which the crowded degree is smaller than the second specified value. Furthermore, the sending section 1702 changes the content data which is sent to the digital signage apparatus 33 arranged in the area h of which the crowded degree is equal to or greater than the specified value to the content data which is sent to the digital signage apparatus 33 arranged in the area d of which the crowded degree is smaller than the second specified value. Thus, in order to ease the crowded state with customers in the area of which the crowded degree is high, the content data of commodities sold in other areas in the store can be displayed in the area having a high crowded degree with customers. Therefore, the customers pay attention to commodities sold in other areas and are able to be guided to other areas.

In this way, according to the third embodiment, in order to ease the crowded state in the area of which the crowded degree is high, the store server 1700 changes the content data which is sent to the digital signage apparatus 33 arranged in the area of which the crowded degree is equal to or greater than the specified value within the digital signage apparatuses 33 arranged in all the areas to the content data which is sent to the digital signage apparatus 33 arranged in the area excluding the area of which the crowded degree is equal to or greater than the specified value. Thus, the digital signage apparatus 33 arranged at the area having a high crowded degree with customers displays the content data of the area other than the area having a high crowded degree. As a result, customers who look at the display in the area having a high crowded degree can be guided to areas other than the area having a high crowded degree with customers in the store.

As described above, according to the first to the third embodiments, the customer can be guided according to the crowded degree with customers in the store.

The program executed by the store server apparatus and the digital signage apparatus of the present embodiment is provided by being recorded in a computer-readable recording medium such as a CD-ROM, a flexible disk (FD), a CD-R, a DVD (Digital Versatile Disk) and the like with a file in an installable manner or an executable manner.

In addition, the program executed by the store server apparatus and the digital signage apparatus of the present embodiment may be also provided by being stored in a computer connected with a network such as an internet and the like and downloaded through the network. In addition, the program executed by the store server apparatus and the digital signage apparatus of the present embodiment may be also provided or assigned through the network such as the internet and the like.

The program executed by the store server apparatus of the present embodiment is a module configuration including each section (the position inquiry section, the crowding degree acquirement section and the sending section) mentioned above, as actual hardware, the CPU (processor) reads out the program from the storage medium mentioned above and executes the program, and thus, each section mentioned above is loaded on a main storage apparatus, and the position inquiry section, the crowding degree acquirement section and the sending section are generated on the main storage apparatus.

In addition, the program executed by the digital signage apparatus of the present embodiment is a module configuration including each section (the position information reception section, the content inquiry section, the content reception section and the content regeneration section) mentioned above, as the actual hardware, the CPU (processor) reads out the program from the storage medium mentioned above and executes the program, and thus, each section mentioned above is loaded on the main storage apparatus, and the position information reception section, the content inquiry section, the content reception section and the content regeneration section are generated on the main storage apparatus.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An information processing apparatus, comprising:
a sending section configured to send a display data to a display apparatus arranged at each area in a store; and
an acquiring section configured to acquire a crowded degree with customers in each area, wherein
the sending section changes the display data which is sent to the display apparatus arranged at a first area of which at least the crowded degree is equal to or greater than a specified value within the display apparatuses respectively arranged in each area.

2. The information processing apparatus according to claim 1, wherein the sending section changes the display data which is sent to the display apparatus arranged at the first area to a display data which is sent to the display apparatus arranged at a second area of which the crowded degree is smaller than a second specified value smaller than the specified value.

3. The information processing apparatus according to claim 1, wherein the sending section changes the display data which is sent to the display apparatus arranged at the first area to a display data including a special-sale information of a special-sale item within commodities sold in the areas.

4. The information processing apparatus according to claim 1, wherein the sending section changes the display data which is sent to the display apparatus arranged at the first area to the display data which is sent to the display apparatus arranged at an area other than the first area.

5. The information processing apparatus according to claim 2, wherein the sending section changes the display data which is sent to the display apparatus arranged at the first area to the display data including guidance information for guiding a path leading to the second area.

6. A method for sending a display data from an information processing apparatus to a display apparatus arranged at each area in a store, comprising:
acquiring a crowded degree with customers in each area;
changing a first display data which is sent to the display apparatus arranged at a first area having a high crowded degree within the display apparatuses in the store to a second display data which is sent to the display apparatus arranged at a second area other than the first area; and
sending the second display data to the display apparatus arranged at the first area.
